(19) United States
(12) Patent Application Publication
(10) Pub. No.: US 2024/0338443 A1
(43) Pub. Date: Oct. 10, 2024

(54) INTERPRETING CODE OF A FILE TO DETERMINE MALICIOUS BEHAVIOR

(71) Applicant: OPSWAT Inc., Tampa, FL (US)

(72) Inventor: Jan Kristian Dirk Miller, Hamburg (DE)

(73) Assignee: OPSWAT Inc., Tampa, FL (US)

(21) Appl. No.: 18/297,923

(22) Filed: Apr. 10, 2023

(51) Int. Cl. G06F 21/56

(52) U.S. Cl. CPC G06F 21/563; G06F 2221/033

(57) ABSTRACT

Code of a target suspect file is interpreted, instead of being executed, to determine potential malicious behavior of the target suspect file. If there are multiple execution paths, an action that would be performed in an execution path that is dependent on a conditional test is interpreted to determine what its behavior would be. If the target suspect file would perform a potential detection-avoidance technique, the potential detection-avoidance technique is bypassed, and actions that the target suspect file would perform are interpreted regardless of the detection-avoidance technique.

### BACKGROUND

In computer malware situations, some of the most sophisticated types of attack vectors by malicious actors are multi-staged. A first stage may involve documents with active content (e.g., Microsoft Office™ documents with Visual Basic for Applications (VBA) for Office macro code that auto-execute or are triggered by specific user input actions). In a second stage or further stages, the VBA macro may download an additional file (or launch secondary scripts or system tools to perform the download) which contains the malicious code (e.g., source code or binary code). In other types of multi-stage attacks, a malicious actor might send unrelated “single stage” files for reconnaissance purposes only and, using the result of reconnaissance, then craft the multi-stage or second stage “real” attack file.

During the first stage, to avoid early detection (e.g., by an automated security solution) of the malicious actor's backend infrastructure and second stage Indicators of Compromise (IOCs), the first stage sample is written to execute only on a computer within a specific target environment. This tactic avoids detection by not performing a full execution of the malware within a non-target environment, since a standard practice of automated security solutions is to attempt to “detonate” or activate a potential malware sample in a special streamlined isolated environment to extract backend infrastructure and IOCs, rather than allowing the sample to detonate in a real environment. If the first stage sample detects that it is within the desired target environment, only then does it execute a branch or path within its code that triggers the second stage and exhibit malicious behavior. On the other hand, if the first stage sample does not detect that it is within the desired target environment, then it does not attempt to perform any operations that lead to the second stage. Instead, the first stage sample executes a different branch or path that might perform an innocuous action or no action (i.e., a non-malicious or void action), so that any anti-malware solution (i.e., programs for detecting and preventing malware attacks) at the environment might be less likely to detect that the first stage sample is a potential threat. In this manner, the first stage sample can potentially avoid detection of its full malicious capabilities.

To determine whether the first stage sample is within the desired target environment, the malicious actor typically uses the first stage sample to perform reconnaissance (i.e., fingerprint) of the environment that it is within. Such reconnaissance of the environment may include checks for a particular characteristic or feature, such as geofencing (i.e., checking an external service or database for a geographic region of a current network connection), specific application version requirements (e.g., by “VBA stomping”), a system user, a username, a system location, available peripheral devices, network resources, and/or a system language, among others. VBA stomping is the process of replacing VBA source code with compiled P-code. Because most analysis tools and antimalware engines only check the VBA source code, the malicious P-code can potentially go undetected and execute if the VBA source code is only modified to seem like something benign.

When the first stage (or “reconnaissance stage” or phase) sample detects that it is within the desired target environment, e.g., the reconnaissance detects that the environment has one or more particular characteristics or features, then the first stage sample proceeds with the second stage. In some cases, the first stage sample is specifically designed to work only in a specific environment. The second stage may be initiated by downloading a malware file, which gets executed on the computer within the environment and can take advantage of the detected characteristic or feature. Alternatively, the first stage sample can transmit information regarding the detected characteristic or feature back to the backend or computer system of the malicious actor, so that the malicious actor can craft a second stage sample that is pre-conditioned to execute within the detected environment.

A problem for the security solution of the targeted environment is that the exact desired target environment may not be known ahead of time and cannot be determined via static analysis of the first stage sample due to heavy obfuscation of the intended actions thereof. Thus, a “golden image” environment or a forensic analysis (performed pre-execution of the first stage sample) may be used to discover the particular environment requirements, characteristics or features that would lead the first stage sample to advance its execution to a point that the security solution can detect the malicious behavior of a custom, targeted zero-day (first-stage) malware of a sophisticated malicious actor.

For a golden image environment, a decoy or duplicate of the real environment is set up as a fake environment (e.g., in a “sandbox” that is an isolated environment that performs instrumentation of the application/OS layer to “monitor” the execution/runtime behavior of input suspect files) that includes many or all of the characteristics or features of the real environment. Then when a suspect file is directed to the real environment, the security solution redirects it to the fake environment. The fake environment then executes the suspect file in such a manner that the suspect file cannot detect whether it is in the real environment. Thus, if the suspect file of a first stage sample would detect the particular environment requirements, characteristics or features that it is expecting in the real environment, it will also detect it in the fake environment and will then proceed to the second stage of its attack. Within the fake environment, however, the suspect file can do no harm to the real environment. Instead, both its first stage and second stage actions are monitored by the security solution to determine whether its behavior is or appears to be malicious.

A further problem, however, is that if the first stage sample does not detect the particular environment requirement, characteristic or feature that it is looking for, then it will not exhibit its malicious behavior. In this case, its malicious capabilities may go undetected by the security solution, and, although the first stage sample might not present a potential danger to the real environment for this event, an opportunity to detect a malicious attack will be lost, which may still pose a threat to a different environment and may continue to propagate after it is passed to the real environment.

### SUMMARY

In some embodiments, a system or method receives a target suspect file that has multiple execution paths, interprets code of the target suspect file to determine each of the execution paths, determines that a first execution path of the multiple execution paths is dependent on a conditional test, interprets the code of the target suspect file to determine whether an action that the target suspect file would perform upon being executed in the first execution path of the multiple execution paths would exhibit malicious behavior, and denies entry of the target suspect file into a computing environment in response to determining that the action would exhibit malicious behavior.

In some embodiments, the interpreting functions are performed without executing the code of the target suspect file. In some embodiments, the interpreting functions are performed by analyzing the code of the target suspect file. In some embodiments, the system or method grants entry of the target suspect file into the computing environment in response to determining that no action that the target suspect file would perform upon being executed in any of the execution paths would exhibit malicious behavior. In some embodiments, the system or method interprets the code of the target suspect file to determine that a set of actions that the target suspect file would perform upon being executed would be a potential environment check and bypasses the potential environment check. In some embodiments, the system or method interprets the code of the target suspect file to determine that a first action of the set of actions would be a read instruction of data that would be indicative of a particular characteristic or feature of the computing environment and interprets the code of the target suspect file to determine that a second action of the set of actions would be a conditional test that would use the data that would have been read; wherein the read instruction and the conditional test are the potential environment check. In some embodiments, the system or method obtains the data by emulating the read instruction. In some embodiments, the system or method interprets a first instruction that the target suspect file would perform upon being executed as part of a reconnaissance stage of a multi-stage attack. In some embodiments, the system or method interprets a second instruction that the target suspect file would perform upon being executed as part of an attack stage of a multi-stage attack.

In some embodiments, a system or method receives a target suspect file, interprets code of the target suspect file to determine that a set of actions that the target suspect file would perform upon being executed would be a detection-avoidance technique, bypasses the detection-avoidance technique, interprets the code of the target suspect file to determine each action that the target suspect file could potentially perform regardless of the detection-avoidance technique, determines whether an action that the target suspect file could perform upon being executed would exhibit malicious behavior, and denies entry of the target suspect file into a computing environment in response to determining that the action would exhibit malicious behavior.

In some embodiments, the system or method interprets the code of the target suspect file to determine that the detection-avoidance technique is a potential environment check. In some embodiments, the system or method interprets the code of the target suspect file to determine that a first action of the set of actions would be a read instruction of data that would be indicative of a particular characteristic or feature of the computing environment and interprets the code of the target suspect file to determine that a second action of the set of actions would be a conditional test that would use the data that would have been read; wherein the read instruction and the conditional test are the potential environment check. In some embodiments, the system or method obtains the data by emulating the read instruction. In some embodiments, the system or method interprets a first instruction that the target suspect file would perform upon being executed as part of a reconnaissance stage of a multi-stage attack. In some embodiments, the system or method interprets a second instruction that the target suspect file would perform upon being executed as part of an attack stage of a multi-stage attack. In some embodiments, the system or method interprets the code of the target suspect file to determine that the detection-avoidance technique is a sleep-delay technique with a sleep instruction that would cause the target suspect file not to be executed for a period of time and emulates the sleep instruction to complete it immediately. In some embodiments, the system or method interprets the code of the target suspect file to determine that the detection-avoidance technique includes an instruction repeated in a loop and exits the loop after detecting a predetermined number of the instruction. In some embodiments, the system or method interprets the code of the target suspect file to determine that the code of the target suspect file includes multiple execution paths and interprets the code of the target suspect file to determine an action that the target suspect file could perform upon being executed for an execution path of the multiple execution paths that is dependent on a conditional test. In some embodiments, the interpreting functions are performed without executing the code of the target suspect file.

In some embodiments, the system or method interprets the code of the target suspect file to determine that the detection-avoidance technique includes a first execution path that the target suspect file would perform in response to an environment check producing a first result, interprets the code of the target suspect file to determine that code of the first execution path would exhibit non-malicious behavior, interprets the code of the target suspect file to determine that the detection-avoidance technique includes a second execution path that the target suspect file would perform in response to the environment check producing a second result, and interprets the code of the target suspect file to determine that code of the second execution path would exhibit the malicious behavior.

### BRIEF DESCRIPTION OF THE DRAWINGS

FIG. 1 shows a schematic diagram of a simplified example conventional system for detecting malware.

FIG. 2 shows a flowchart of a simplified example conventional process for a virtual machine to execute a target suspect file.

FIG. 3 shows a schematic diagram of a simplified example system for detecting malware in accordance with some embodiments.

FIG. 4 shows a flowchart of a simplified example conventional process for an emulator to emulate a target suspect file, in accordance with some embodiments.

FIG. 5 shows a table of results of an example test that compared the improvements of the emulator described with respect to FIGS. 3 and 4 with a conventional sandbox or virtual machine.

FIG. 6 shows a simplified flowchart of an example process for the emulator described with respect to FIGS. 3 and 4 to analyze a Microsoft Office document/file, in accordance with some embodiments.

FIG. 7 is a simplified schematic diagram of an example computer system for use in the system and methods described with respect to FIGS. 3-6, in accordance with some embodiments.

### DETAILED DESCRIPTION

In accordance with some embodiments, a system and method for analyzing and detecting malware inspects every possible branch or path of the code of a target suspect file that has multiple possible execution paths. In accordance with some embodiments, the system and method preferably inspects only those branches or paths that it identifies or marks as depending on a “sensitive condition” for which the potential malware would perform a check. The system and method does this by interpreting the code through each path without actually executing it, since executing the code would potentially give the suspect file some measure of control over how it behaves and which path it would take. Thus, the system and method maintains full control over the flow of the code, can analyze the data flow, and can manipulate the control flow to discover potential malicious activity. In this manner, the system and method can analyze the entire code of the suspect file in a single automated pass. The system and method can also skip or reduce some steps of the code that are designed to obfuscate or delay execution of the intended function of the suspect file; thereby reducing the time required for the overall analysis and malware detection.

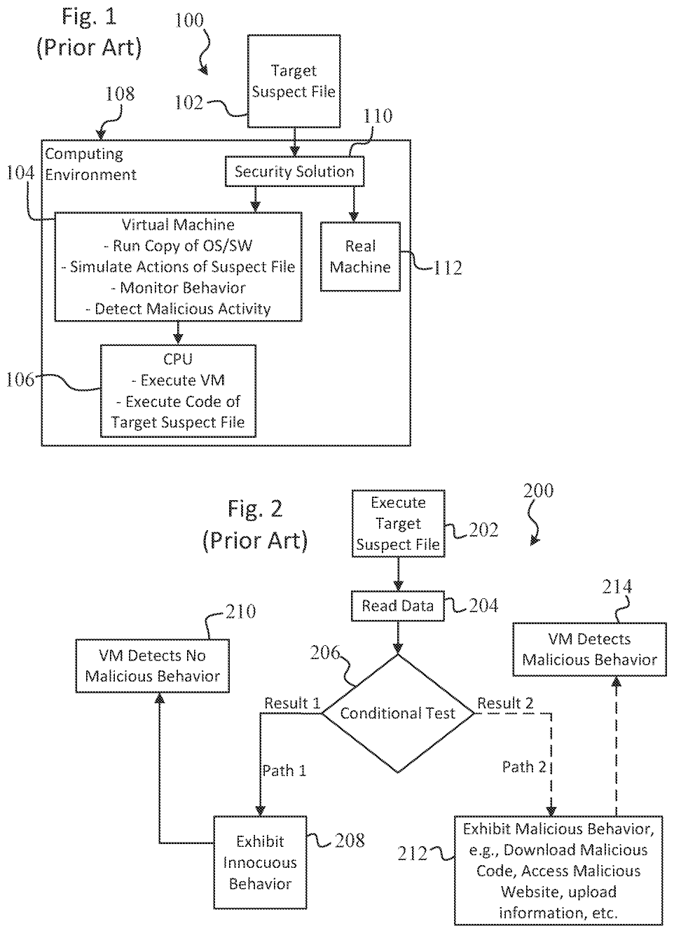

A simplified example conventional system and method for detecting malware using a virtual machine is shown in FIGS. 1 and 2. The example illustrates one type of technique that malware can use to attempt to avoid detection by such an example conventional system and method. Additionally, there are other ways that malware could potentially avoid a conventional security screening by a virtual machine, but which the present invention can detect, as will become apparent from the description below.

FIG. 1 shows a schematic diagram of a simplified example conventional system 100 for detecting malware. In the conventional system 100, a target suspect file (i.e., potential malware) 102 is received in a computing environment 108 and directed to a virtual machine (VM) 104, instead of to a real machine 112, by a security solution 110 of the computing environment 108. The virtual machine 104 runs copies of the operating system (OS) and other software (SW) that are used in the computing environment 108, such that the virtual machine 104 appears to the target suspect file 102 to be the real machine 112 in the computing environment 108, so the target suspect file 102 runs in the virtual machine 104 in the same manner that it would run if it were in the real machine 112. Thus, the virtual machine 104 runs the target suspect file 102 in a simulated environment to recreate the actions thereof. The virtual machine 104 also monitors the behavior of the actions of the target suspect file 102 to potentially detect any malicious activity performed thereby. Additionally, one or more central processing units (CPU) 106 execute both the virtual machine 104 and the code of the target suspect file 106 in the same manner that a CPU would do for the real machine 112.

FIG. 2 shows a flowchart of a simplified example conventional process 200 for when the virtual machine 104 executes (at 202) the target suspect file 102 on the CPU 106. In this example, the target suspect file 102 has multiple execution paths. At some point in its execution, the target suspect file 102 reads (at 204) data that is expected to indicate whether the target suspect file 102 is executing within the computing environment 108 that the malicious actor has desired to target with an attack. For example, the data may be indicative of a particular characteristic, feature, or sensitive condition of the computing environment 108, such as geofencing, specific application version requirements (e.g., “VBA stomping”), a system user, a username, a system location, available peripheral devices, network resources, and/or a system language, among others. At a later point in its execution, the target suspect file 102 performs (at 206) a conditional test on the data read at 204. The read data at 204 and the conditional test at 206 are, thus, a check for whether the particular characteristic or feature is present within the computing environment 108, which might provide a potential entry point for a second stage attack on the computing environment.

In a first result of the check (result 1), the conditional test determines that a desired characteristic or feature is not present (or an undesired characteristic or feature is present), so the target suspect file 102 branches to a first execution path (path 1) in which the target suspect file 102 exhibits (at 208) innocuous, or non-malicious, behavior or activity. In this case, the virtual machine 104 detects (at 210) no malicious behavior by the target suspect file 102, so the target suspect file 102 is allowed to proceed to the real machine 112 in the computing environment 108. Alternatively, the security solution 110 might subject the target suspect file 102 to further analysis. A person might even be called upon to manually investigate the target suspect file 102.

In a second result of the check (result 2), on the other hand, the conditional test determines that the desired characteristic or feature is present (or an undesired characteristic or feature is not present), so the target suspect file 102 branches to a second execution path (path 2) in which the target suspect file 102 exhibits (at 212) malicious behavior or activity, i.e., the malware is executed or “detonated”. For example, the target suspect file 102 might download an additional file that contains malicious code, access a malicious website, upload information about the computing environment 108 to the backend or computer system of the malicious actor, or perform some other action that the security solution 110 of the computing environment 108 determines is malicious or otherwise improper or not allowed. In this case, the virtual machine 104 detects (at 214) malicious behavior by the target suspect file 102, so the target suspect file 102 is not allowed to proceed to the real machine 112 in the computing environment 108. Instead, the security solution 110 deletes, quarantines, or takes other appropriate action with the target suspect file 102.

As can be seen from the example of FIGS. 1 and 2, since the virtual machine 104 cannot manipulate the control flow, the example conventional system and method could possibly fail to detect the malicious behavior of the target suspect file 102 when the execution of it simply avoids performing the malicious behavior, e.g., via path 1, after performing its reconnaissance of the computing environment 108. This could happen at least after a first pass at trying to detect malicious behavior by the virtual machine 104. If any further analysis or manual investigation of the target suspect file 102 also fails (or is not performed), then the target suspect file 102 could potentially be passed to the real machine 112 in the computing environment 108. If this occurs, then, although the check performed at 204 and 206 by the target suspect file 102 would likely present the same result in the real machine 112, i.e., the innocuous behavior at 208, the target suspect file 102 could nevertheless possibly continue to propagate to other machines in the computing environment 108 or to other environments, where it could eventually perform its malicious behavior. Thus, an opportunity to stop a malicious file from entering a computing environment as early as possible would be lost.

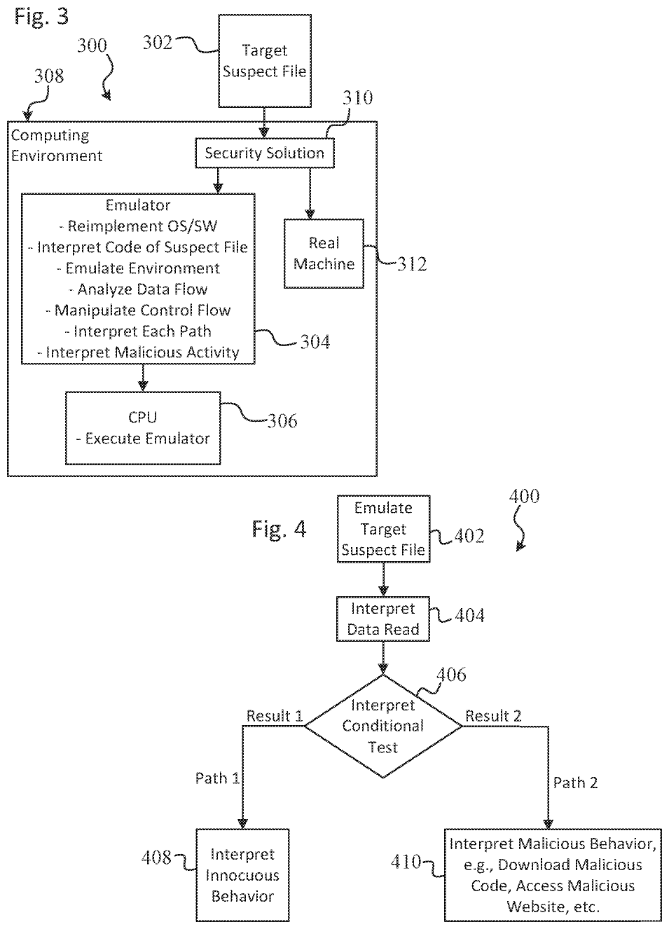

A simplified example system and method for detecting malware in accordance with some embodiments is shown in FIGS. 3 and 4. The example illustrates how some embodiments of the present invention can detect malware that uses a detection-avoidance technique, e.g., the detection-avoidance type of technique illustrated by the example of the conventional system and method of FIGS. 1 and 2. Additional embodiments can also detect malware that use other ways to attempt to avoid conventional security screenings of a virtual machine, as will become apparent from the description below.

FIG. 3 shows a schematic diagram of a simplified example system 300 for detecting malware in accordance with some embodiments. In the system 300, a target suspect file 302 (i.e., potential malware similar to or the same as the target suspect file 102) is received in a computing environment 308 and directed to an emulator 304, instead of to a real machine 312, by a security solution 310 of the computing environment 308. (The real machine 312 is assumed to be the target computer system that the malicious actor intends to attack.) The emulator 304 includes re-implementations of the operating system (OS) and other software (SW) that are used in the computing environment 308. The emulator 304 uses the reimplemented operating system and other software to interpret the code of the target suspect file 302 by analyzing the code rather than executing it. The code interpretation analyzes the code to determine the actions or steps that the code is intended to perform, rather than executing the code and monitoring its actions or behavior as in the virtual machine 104. The reimplemented operating system and other software, thus, emulate the computing environment 308 without duplicating it. In other words, the reimplemented operating system and other software emulate the same acts and steps of logic operating system and other software but are not a full copy thereof that is capable of fully executing the target suspect file 302 as in the virtual machine 104. Thus, in this context, the term “emulate” refers to dynamic analysis and interpretation of program code; whereas, the term “simulate” refers to an attempt at re-creating the actual execution and loading mechanisms of the supported proprietary file formats for the target suspect file. The target suspect file is executed in a simulation, as in the virtual machine 104.

Since the code of the target suspect file 302 is not executed, the emulator 304 is not intended to appear to the target suspect file 302 to be the real machine 312. One or more central processing units (CPU) 306, therefore, execute only the emulator 306 and not the target suspect file 302.

The emulator 304 emulates the environment of the real machine 312 in order to interpret the code of the target suspect file 302 to analyze the data flow and manipulate the control flow thereof. Since the emulator 304 has full control of the code at an instruction level, it can determine which path(s) to interpret, or it can interpret each path thereof, instead of being restricted to whichever path(s) the code would take when being executed. In this manner, the emulator 304 can interpret any potential malicious activity (that could occur upon executing the code) throughout the entire code.

FIG. 4 shows a flowchart of a simplified example conventional process 400 for when the emulator 304 emulates (at 402) the target suspect file 302, in accordance with some embodiments. The particular steps, order of steps, and combination of steps are shown for illustrative and explanatory purposes only. Other embodiments can implement different particular steps, orders of steps, and combinations of steps to achieve similar functions or results.

In this example, the target suspect file 302 has multiple execution paths or pathways. Additionally, the actions of the target suspect file 302 are representative of a first stage of a multi-stage attack, i.e., the reconnaissance stage of the attack. The emulator 304 interprets each line or step of the code of the target suspect file 302 and eventually reaches the read data instruction (executed at 204 in FIG. 2). Thus, at 404, the emulator 304 interprets this as a data read instruction and analyzes the data flow to determine that an intended action of the target suspect file 302 is to read a particular data value. The emulator 304 identifies and records the data read instruction (and optionally the actual data that would have been read by the instruction) as an “event”. (An “event” is an instruction of interest, which is a type of instruction that potentially could be used by a malicious file as part of a reconnaissance stage or an attack stage.) Additionally, the emulator 304 may interpret that the data would be potentially indicative of a particular characteristic or feature of the computing environment 108, such as geofencing, specific application version requirements (e.g., “VBA stomping”), a system user, a username, a system location, available peripheral devices, network resources, and/or a system language, among others. In some embodiments, the emulator 304 emulates the data read instruction and actually obtains the data value or spoofs the data value with a reasonable fake value. At a further point in the interpretation of each line or step of the code of the target suspect file 302, the emulator 304 reaches the conditional test instruction (executed at 206 in FIG. 2). At 406, the emulator 304 interprets this as an event that is a conditional test that would use the data that would have been read at 404 by the target suspect file 302, i.e., detection of a “sensitive condition”. Thus, the emulator 304 further analyzes the data flow to determine that an intended action of the target suspect file 302 is to test for a particular condition of the data at the conditional test, which might provide a potential entry point for a second stage attack on the computing environment. Such an entry point is an example instruction that is interpreted by the emulator 304 as being an instruction of interest or event.

In some embodiments, the emulator 304 interprets the conditional test (at 406) to determine each execution path that the code of the target suspect file 302 could take depending on the result of the conditional test, i.e., to determine the code that the target suspect file 302 would execute and each action that the target suspect file 302 would perform for each result that could occur or each execution path. In the example shown in FIG. 4, the conditional test (at 406) would produce either a first result (result 1) (that would cause the target suspect file 302 to branch to a first execution path (path 1)) or a second result (result 2) (that would cause the target suspect file 302 to branch to a second execution path (path 2)). In some embodiments, the emulator 304 uses a control flow retry tree to analyze only those execution paths that are dependent on the conditional test resulting in detecting the presence of the particular characteristic, feature or sensitive condition of the computing environment. In other words, the emulator 304 selects only those one or more paths that are likely to exhibit malicious behavior or are potentially part of a first stage of a multi-stage attack. In other embodiments, the emulator 304 analyzes every possible execution path, since it might not be possible to determine which result is the one desired by the malicious actor.

In some embodiments, the emulator 304 does not have to determine what the actual result of the conditional test at 406 would have been in the real machine 312. Instead, the emulator 304 can emulate the conditional test resolving it in accordance with whichever result would indicate the presence of the particular characteristic, feature or sensitive condition of the computing environment and then interpreting the code of the path thus indicated. Alternatively, the emulator 304 can first resolve the conditional test as if it were to produce result 1 (and then proceed to interpret the code that would be executed in that event, i.e., in path 1) and then resolve it as if it were to produce result 2 (and then proceed to interpret the code that would be executed in that event, i.e., in path 2). In this manner, the emulator 304 manipulates the control flow of the target suspect file 302 to follow the path of the code that it determines is dependent on the potential event or conditional test result (or alternatively each potential path of the code) and interprets each potential action or behavior that would occur for that path(s). Additionally, the emulator 304 does this in just one pass through the code, which a virtual machine typically cannot do.

In some embodiments, the emulator 304 may interpret the combination of the events of the data read and the conditional test as being a set of actions that would be a potential environment check or evasion check for whether the particular characteristic or feature is present within the computing environment 108. However, since the emulator 304 follows each potential path of the code and interprets each potential action or behavior that the target suspect file could potentially perform regardless of the environment check, the emulator 304 in effect bypasses the environment check or other detection-avoidance technique.

As an example, the malicious actor might intend to attack a computer system of a particular person or organization, so part of the intended action of the target suspect file 302 would be to perform an environment check to determine if the username of the user of the target computer system matches an expected or potential username. Thus, the data value that would be read at 404 would be the username for the target computer system, and the conditional test at 406 would be a comparison with the intended or target username. (Similar environment checks can be done for each of the other particular characteristics or features of the computing environment 108 that the target suspect file 302 could exploit.) For example, the emulator 304 might first interpret or resolve the result as indicating that the username comparison would not produce a match (i.e., result 1, since the username for the target computer system is not the intended username, thereby indicating that the target computer system is not the intended target computer system), so the emulator 304 further interprets or resolves the result as indicating that the target suspect file 302 would respond to the conditional test at 406 as branching to execute the code of path 1. In this case, the emulator 304 proceeds (at 408) to interpret the code of path 1 and, thereby, determines that the target suspect file 302 would perform one or more actions that exhibit innocuous behavior, i.e., non-malicious behavior. Then the emulator 304 proceeds to interpret or resolve the result as indicating that the username comparison of the conditional test at 406 would produce a match (i.e., result 2, since the username for the target computer system is the intended username, thereby indicating that the target computer system is the intended target computer system), so the emulator 304 further interprets or resolves the result as indicating that the target suspect file 302 would respond to the conditional test at 406 as branching to execute the code of path 2. In this case, the emulator 304 proceeds (at 410) to interpret the code of path 2 and, thereby, determines that the target suspect file 302 would perform one or more actions that exhibit malicious behavior or potentially malicious behavior, e.g., based on IOCs of a second stage of the multi-stage attack. (The emulator 304 can also generate new IOCs based on the detected malicious behavior or potentially malicious behavior to update malware detection capability of the emulator 304 and security solution 310.) For example, the emulator 304 might interpret that the actions of the target suspect file 302 in path 2 would download malicious or suspect code or access a malicious or suspect website, among other possibilities that would not be allowed for the real machine 312. Thus, the emulator 304 manipulates the control flow of the target suspect file 302 to follow both path 1 and path 2 of the code and interpret each potential action or behavior that would occur for both conditional test results.

In response to determining that the target suspect file 302 would exhibit or perform at least one malicious behavior or action (or potentially malicious behavior or action) upon being executed in any execution path of its multiple execution paths, the emulator 304 or the security solution 310 denies entry of the target suspect file 302 to the computing environment 308 or the real machine 312 or sanitizes the target suspect file 302 before granting entry. On the other hand, in response to determining that the target suspect file 302 would exhibit or perform no malicious behavior or action (or potentially malicious behavior or action) upon being executed in any execution path of its multiple execution paths, the emulator 304 or the security solution 310 grants entry of the target suspect file 302 to the computing environment 308 or the real machine 312.

In some embodiments, the emulator 304 generally interprets the code of the target suspect file 302 to determine, identify, avoid and/or overcome whatever technique(s) the target suspect file 302 uses to obfuscate, or avoid detection of, its intended malicious behavior. The environment check by the target suspect file 302 described above with respect to FIGS. 1-4 is an example of possible obfuscation or detection-avoidance techniques, and the interpretation (instead of execution) of the code of the target suspect file 302 through each possible path is an example of detection techniques of the emulator 304 to detect, avoid, bypass and/or overcome such obfuscation or detection-avoidance techniques. Additionally, the emulator 304 detects, avoids, bypasses and/or overcomes the other obfuscation or detection-avoidance techniques described herein.

Another example obfuscation or detection-avoidance technique by a target suspect file can involve a sleep-delay technique. This technique exploits the fact that many conventional virtual machines have a time limit for how long they will attempt to execute a target suspect file. Thus, if execution of the target suspect file does not exhibit potentially malicious behavior within a given time period (e.g., 1-5 minutes), then the virtual machine stops the execution thereof, and the security solution either proceeds with a different malware detection technique or declares the target suspect file not to be malicious. Therefore, if the target suspect file simply delays its execution (or execution of the malicious portion thereof) with a sleep instruction that causes the target suspect file not to be executed for a long enough sleep time period, then the target suspect file might avoid detection by many types of conventional virtual machines.

Some target suspect files might instigate a conventional sleep for a time period of 10-100 minutes or more. Since some malware runs in the background, such a long sleep might not use the CPU at such a level that would potentially draw attention to it. Additionally, a relatively long Sleep can reduce a request count to a server of potential malware; thereby also potentially preventing attention being drawn to the target suspect file due to such requests.

In some embodiments, therefore, when the emulator 304 interprets an instruction in the code of the target suspect file as a sleep instruction, then the emulator 304 records this as an event and then manipulates the control flow to emulate the sleep instruction to complete it immediately, i.e., without waiting for the sleep period of time, but as if the sleep instruction had caused the target suspect file to sleep for the period of time that the target suspect file was intended to sleep. Then the emulator 304 continues interpreting subsequent instructions as if the sleep instruction had been executed for the intended time period. In other words, instead of executing the sleep instruction, or instead of reducing the time period of the sleep instruction, the emulator 304 simply proceeds to interpret the subsequent instructions to determine how the subsequent instructions would execute if the sleep had been performed in accordance with a system clock, i.e., a fake sleep with a fake system clock. In this manner, the emulator 304 detects, avoids, bypasses and/or overcomes the sleep-delay obfuscation or detection-avoidance technique.

A variation on the above-described sleep delay detection-avoidance technique is for the target suspect file to perform a repeated loop of many very short sleep instructions or other instructions that are intended to delay execution of the target suspect file. Some malicious actors might use this technique to avoid virtual machines that can reduce the time period for a sleep instruction. In this manner, even if the virtual machine reduces the time period for each of the sleep instructions, it still has to execute through the loop many times, which would still have the overall effect of a long sleep. In some embodiments, therefore, the emulator 304 can break such a loop. In other words, when the emulator 304 detects that it has interpreted a repeat of events or pattern of events (e.g., one or more events in sequence that keep repeating), then the emulator 304 breaks (i.e., exits) out of the loop and proceeds to interpret the next instructions after the loop. In this manner, the emulator 304 detects, avoids, bypasses and/or overcomes this variation of the sleep-delay obfuscation or detection-avoidance technique.

Another example obfuscation or detection-avoidance technique by a target suspect file that involves a loop can occur when the target suspect file is trying to reach out to a network endpoint or URL (Uniform Resource Locator), but that network endpoint is down or not responding. In this case, the target suspect file might keep attempting to ping the network endpoint, waiting for it to come online or respond. In another example obfuscation or detection-avoidance technique, the target suspect file might be intended to execute a loop in order to wait for a command, e.g., from the user, the malicious actor, or another file.

Another example obfuscation or detection-avoidance technique by a target suspect file may involve malicious code that does not execute or detonate unless a mouse pointer hovers over a certain spot in the display of the target suspect file (e.g., a Microsoft Office file, such as a MS Word or MS Excel document) or a user inputs a click on a specific display button, among others. A virtual machine would not detect such events, since an automated analysis of the execution of the target suspect file would not include an action by a person moving or clicking a mouse pointer. The emulator 304, however, can detect the malicious code in this situation, since the emulator 304 analyzes and interprets every possible path of the target suspect file.

Another example obfuscation or detection-avoidance technique by a target suspect file may include VBA stomping with a Visual Basic p-code binary file. The p-code can be executed only in the same version of MS Office that it was created/compiled in. Therefore, if the malicious actor knows the MS Office version of the intended target computer system, then the malicious actor can compile the VBA macro code to p-code, delete the VBA macro code from the target suspect file, and keep only the p-code in the target suspect file. Then, if the virtual machine does not have the same version of MS Office, it will not execute the p-code, so any malicious behavior thereof will not be detected by a conventional virtual machine or special streamlined isolated environment. Therefore, in some embodiments, if the target suspect file includes a Visual Basic p-code binary file, the emulator 304 decompiles the Visual Basic p-code binary file to VBA code. Then the emulator 304 interprets it like normal VBA code, as described herein. Additionally, if the p-code in the target suspect file does not match p-code that MS Office would compile, then the emulator 304 detects this situation and emulates the p-code.

In the above examples and other potential obfuscation or detection-avoidance techniques that include or use an instruction, multiple instructions, or events repeated in a loop, the emulator 304 can break (i.e., exit) the loop after detecting a predetermined number of the repeating instruction(s) or event(s) and then proceed to interpret the subsequent instructions. Additionally, the emulator 304 can record information regarding new URLs or network endpoints to generate new IOCs upon detecting such a repeated loop. Furthermore, if the target suspect file can attempt to access multiple URLs or network endpoints, then the emulator 304 can analyze and interpret all of them, instead of stopping at a first successful access as would happen if a virtual machine executed the target suspect file.

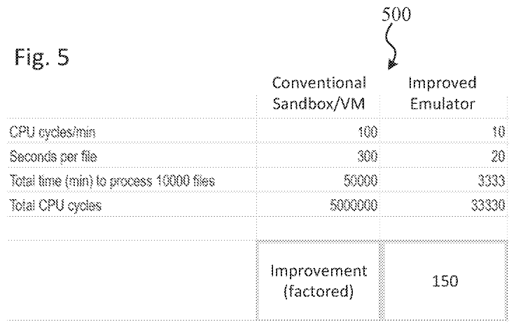

The interpretation of instructions by the emulator 304 is potentially slower than simply executing the same instructions by a virtual machine (e.g., 104), because the interpretation and emulation requires performing additional steps to recalculate or determine what would happen in an actual execution. However, the emulator 304 does not have to emulate every instruction. Instead, as the emulator 304 is interpreting instructions, it can skip emulating instructions that are not interpreted as being of interest, i.e., that are typically considered to be benign or innocuous or not of a type that is typically considered likely to be part of or to aid any type of reconnaissance or an attack. Thus, in some embodiments, the emulator 304 emulates only the instructions of interest or potentially malicious code. Therefore, since the emulator 304 does not have to emulate every instruction, the emulator 304 can be faster than a conventional virtual machine, depending on the percentage of instructions that the emulator 304 has to emulate. Additionally, since the emulator 304 can break loops, as described above, it can significantly shorten the time required for situations that would otherwise slow down a virtual machine. Because of these improvements and advantages over conventional virtual machines, the emulator 304 outperforms traditional sandboxes or virtual machines by 10 times (or more) speed at just 10% of the resource utilization, thereby yielding at least 100 times total resource utilization improvement. An example test that compared the improvements of the emulator 304 with a conventional sandbox or virtual machine is shown in Table 500 in FIG. 5. The results in Table 500 show that the emulator 304 had a 15 times improvement in the total time, and a 150 times improvement in the total number of CPU cycles, required to process 10,000 files, for an overall factored improvement of 150 times

An example situation in which the emulator 304 analyzes a target suspect file can occur with a Microsoft Office™ file (e.g., MS Word, MS Excel, etc.) that includes a VBA (Visual Basic for Applications for Office) macro code (i.e., the target suspect file) that automatically executes. The emulator 304 emulates the VBA functions with a VBA emulator and, therewith, interprets the instructions of the VBA macro code. Thus, the emulator 304 includes a VBA compiler and parser to compile VBA code units into appropriate module declarations for a fake Windows COM system or interface and a VBLibrary or VbaLibrary. Since some VBA macro code use the Windows COM, the emulator 304 includes a reimplementation of at least part of the Windows COM in the fake COM. In some embodiments, the emulator 304 also emulates PowerShell, JavaScript, and system tools, among others.

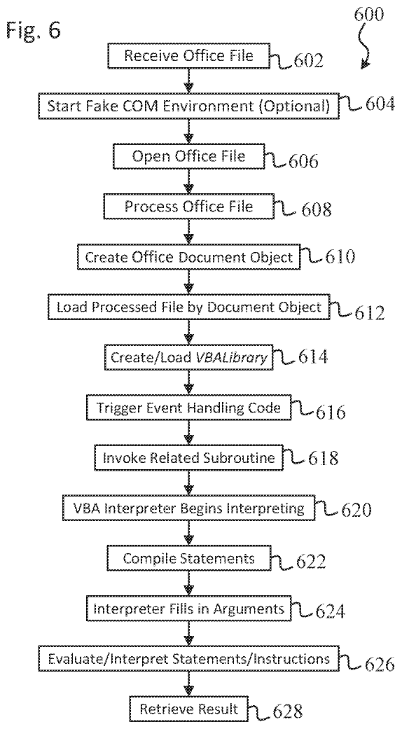

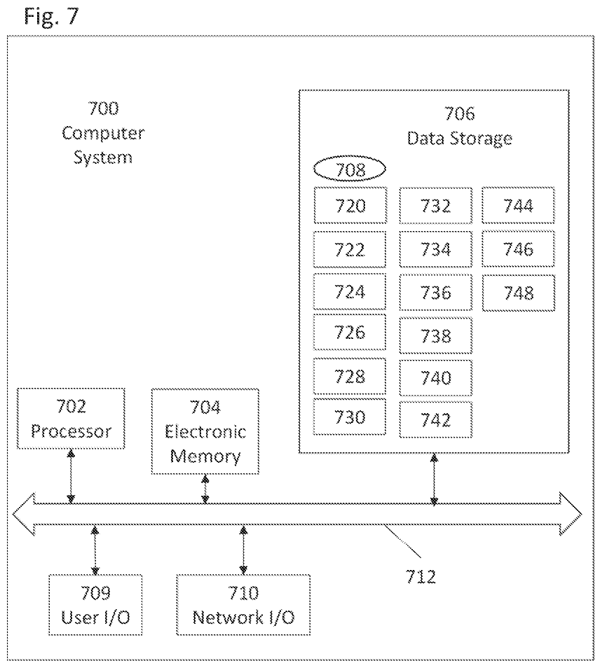

An example process 600 for the emulator 304 to analyze an Office document/file is shown in a simplified flowchart in FIG. 6, in accordance with some embodiments. The particular steps, order of steps, and combination of steps are shown for illustrative and explanatory purposes only. Other embodiments can implement different particular steps, orders of steps, and combinations of steps to achieve similar functions or results.

Upon receiving an Office file at 602, the emulator 304 optionally starts (at 604) the appropriate Office application in the fake COM environment. For a MS Word document, for example, the WordLibrary is loaded as the Exe RuntimeLibrary in the fake COM. Thus, the emulator 304 opens the Office file (at 606), processes the Office file (at 608), and creates a new Office document object (at 610) similar to the real Windows COM functions. At 612, the document object loads the processed document that was processed at 608. At 614, the emulator 304 creates the VbaLibrary, compiles the document object in MS Word to the Document class in VBA, creates an appropriate object with the same name, compiles the appropriate modules declarations into the VbaLibrary, loads the VbaLibrary, and gets the VbaExeRuntimeLibrary (which creates the VBA Interpreter).

Thus far, in some embodiments, the process 600 operates like a module level, as if the VBA macro code can actually load libraries, e.g., Kernel32.dll and NTDLL.DLL, among others in the fake COM. The process 600, thus, creates or sets up a runtime environment for the VBA macro code. If the VBA macro code is supposed to load a library, for example, a fake Library object is created in the emulator 304. To interpret the instructions, therefore, the emulator 304 emulates what the VBA macro code would use, e.g., libraries, system tools, etc. that have been recreated or reimplemented in the emulator 304. If the VBA macro code, for example, were to call a function within Kernel32.dll, a reimplemented fake object (which has the same name and either does not actually do anything or produces an appropriate response) is called. Thus, the fake object can be called, and the emulator 304 can continue interpreting what the VBA macro code would do afterwards. Additionally, in some embodiments, skeleton handler functions (e.g., generated from the symbol information from the Microsoft symbol server) that do not actually do anything can be called, so the emulator 304 can continue interpreting the execution of the VBA macro code. In other words, the fake objects and functions are reimplemented with a bare minimum functionality, which aids in the improvement in the total time it takes to analyze the target suspect file. If the emulator 304 interprets an instruction as intended to manipulate the host system, the fake object responsible for this action does not actually perform the action; and if a subsequent instruction is interpreted as being based on a result of that action, the emulator 304 can further determine what the VBA macro code would do if the action had been performed.

As an example, if the emulator 304 interprets a file-delete instruction, the fake object responsible for this action does not actually delete a target file; and if a subsequent instruction is interpreted as determining whether the target file was deleted, the emulator 304 can further determine what the VBA macro code would do if the target file had been deleted. As another example, if the emulator 304 interprets the VBA macro code to create a file, then a virtual or fake file system maintains that the file is supposed to exist but does not actually create it. Additionally, the emulator 304 can log the data that was intended to be written to the created file if the data is interpreted as being of interest. In other words, when the VBA emulator of the emulator 304 interprets an instruction as a function call to an object, the fake object quickly provides a correct, appropriate or satisfactory response (without executing the instruction or the function call) that the emulator 304 can record if needed, so subsequent analysis and interpretation does not produce a program crash of the VBA macro code. As another example, however, if the emulator 304 interprets an instruction as a certain type of function, such as a string function, it might be necessary to implement the functionality of the string function to deobfuscate the VBA macro code by peeling back layers to determine the intended action thereof. In such situations, the fake object might have to perform a more thorough replica of what the string function would do in order to obtain a useful result.

At 616, the emulator 304 triggers an event handling code (e.g., Document.Open) where events are bound at compile time (e.g., by class or event). Additionally, at 618, a related subroutine is invoked, and the VBS interpreter of the emulator 304 begins interpreting at 620, which compiles the statements of the VBA macro code at 622. For a function call of interest, the VBA emulator creates a new callframe and proceeds to fill in the arguments (at 624) for the function call. At 626, the VBA emulator evaluates or interprets the statements or instructions of the function call of the VBA macro code one by one. At 628, the VBS interpreter retrieves the value of the function name variable as the result of this function call, pops the callframe, and repeats with further interpretation of the VBS macro code until all of the code has been analyzed. If there are nested functions, then the VBA emulator repeats with additional callframes. Additionally, if the VBA macro code performs a detection-avoidance technique, such as any of those described herein, then the VBA emulator of the emulator 304 detects, avoids, bypasses and/or overcomes the detection-avoidance technique as described herein.

Although the example of FIG. 6 is for analyzing and interpreting VBA macro code, a similar process can be done for other types of code.

FIG. 7 is a simplified schematic diagram showing an example computer system 700 (representing any combination of one or more of the computer systems) for use in the example system 300 for detecting malware, in accordance with some embodiments. Other embodiments may use other components and combinations of components. For example, the computer system 700 may represent one or more physical computer devices or servers, such as web servers, rack-mounted computers, network storage devices, desktop computers, laptop/notebook computers, etc., depending on the complexity of the system 300. In some embodiments implemented at least partially in a cloud network potentially with data synchronized across multiple geolocations, the computer system 700 may be referred to as one or more cloud servers. In some embodiments, the functions of the computer system 700 are enabled in a single computer device. In more complex implementations, some of the functions of the computing system are distributed across multiple computer devices, whether within a single server farm facility or multiple physical locations.

In some embodiments where the computer system 700 represents multiple computer devices, some of the functions of the computer system 700 are implemented in some of the computer devices, while other functions are implemented in other computer devices. For example, various portions of the system 300 and the emulator 304 can be implemented on the same computer device or separate computer devices.

In the illustrated embodiment, the computer system 700 generally includes at least one processor 702, at least one main electronic memory 704, at least one data storage 706, at least one user I/O 709, and at least one network I/O 710, among other components not shown for simplicity, connected or coupled together by a data communication subsystem 712.

The processor 702 represents one or more central processing units on one or more PCBs (printed circuit boards) in one or more housings or enclosures. In some embodiments, the processor 702 represents multiple microprocessor units in multiple computer devices at multiple physical locations interconnected by one or more data channels. When executing computer-executable instructions for performing the above described functions of the computer system 700 (i.e., the system 300 and the emulator 304) in cooperation with the main electronic memory 704, the processor 702 becomes a special purpose computer for performing the functions of the instructions.

The main electronic memory 704 represents one or more RAM modules on one or more PCBs in one or more housings or enclosures. In some embodiments, the main electronic memory 704 represents multiple memory module units in multiple computer devices at multiple physical locations. In operation with the processor 702, the main electronic memory 704 stores the computer-executable instructions executed by, and data processed or generated by, the processor 702 to perform the above-described functions of the computer system 700 (i.e., the system 300 and the emulator 304).

The data storage 706 represents or comprises any appropriate number or combination of internal or external physical mass storage devices, such as hard drives, optical drives, network-attached storage (NAS) devices, flash drives, etc. In some embodiments, the data storage 706 represents multiple mass storage devices in multiple computer devices at multiple physical locations. The data storage 706 generally provides persistent storage (e.g., in a non-transitory computer-readable or machine-readable medium 708) for the programs (e.g., computer-executable instructions) and data used in operation of the processor 702 and the main electronic memory 704. The non-transitory computer readable medium 708 includes instructions (e.g., the programs and data 720-748) that, when executed by the processor 702, cause the processor 702 to perform operations including the above-described functions of the computer system 700 (i.e., the system 300 and the emulator 304).

In some embodiments, the main electronic memory 704 and the data storage 706 include all, or a portion of the programs and data (e.g., represented by 720-748) required by the processor 702 to perform the methods, processes and functions disclosed herein (e.g., in FIGS. 3-6). Under control of these programs and using this data, the processor 702, in cooperation with the main electronic memory 704, performs the above-described functions for the computer system 700 (i.e., the system 300 and the emulator 304).

The user I/O 709 represents one or more appropriate user interface devices, such as keyboards, pointing devices, displays, etc. In some embodiments, the user I/O 709 represents multiple user interface devices for multiple computer devices at multiple physical locations. A system administrator, for example, may use these devices to access, set up, and control the computer system 700.

The network I/O 710 represents any appropriate networking devices, such as network adapters, etc. for communicating throughout the system 300 and the emulator 304. In some embodiments, the network I/O 710 represents multiple such networking devices for multiple computer devices at multiple physical locations for communicating through multiple data channels.

The data communication subsystem 712 represents any appropriate communication hardware for connecting the other components in a single unit or in a distributed manner on one or more PCBs, within one or more housings or enclosures, within one or more rack assemblies, within one or more geographical locations, etc.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

What is claimed is:

1. A method comprising:
receiving, by a computer system, a target suspect file that has multiple execution paths;
interpreting, by the computer system, code of the target suspect file to determine each of the execution paths;
interpreting, by the computer system, the code of the target suspect file to determine that a first execution path of the multiple execution paths is dependent on a conditional test;
interpreting, by the computer system, the code of the target suspect file to determine whether an action that the target suspect file would perform upon being executed in the first execution path of the multiple execution paths would exhibit malicious behavior; and
denying, by the computer system in response to determining that the action would exhibit malicious behavior, entry of the target suspect file into a computing environment.

2. The method of claim 1, wherein:
the interpreting functions are performed without executing the code of the target suspect file.

3. The method of claim 1, wherein:
the interpreting functions are performed by analyzing the code of the target suspect file.

4. The method of claim 1, further comprising:
granting, by the computer system in response to determining that no action that the target suspect file would perform upon being executed in any of the execution paths would exhibit malicious behavior, entry of the target suspect file into the computing environment.

5. The method of claim 1, further comprising:
interpreting, by the computer system, the code of the target suspect file to determine that a set of actions that the target suspect file would perform upon being executed would be a potential environment check; and
bypassing, by the computer system, the potential environment check.

6. The method of claim 5, further comprising:
interpreting, by the computer system, the code of the target suspect file to determine that a first action of the set of actions would be a read instruction of data that would be indicative of a particular characteristic or feature of the computing environment; and
interpreting, by the computer system, the code of the target suspect file to determine that a second action of the set of actions would be a conditional test that would use the data that would have been read;
wherein:
the read instruction and the conditional test are the potential environment check.

7. The method of claim 6, further comprising:
obtaining, by the computer system, the data by emulating the read instruction.

8. The method of claim 1, further comprising:
interpreting, by the computer system, a first instruction that the target suspect file would perform upon being executed as part of a reconnaissance stage of a multi-stage attack.

9. The method of claim 8, further comprising:
interpreting, by the computer system, a second instruction that the target suspect file would perform upon being executed as part of an attack stage of a multi-stage attack.

10. A method comprising:
receiving, by a computer system, a target suspect file;
interpreting, by the computer system, code of the target suspect file to determine that a set of actions that the target suspect file would perform upon being executed would be a detection-avoidance technique;
bypassing, by the computer system, the detection-avoidance technique;
interpreting, by the computer system, the code of the target suspect file to determine each action that the target suspect file could potentially perform regardless of the detection-avoidance technique;
determining, by the computer system, whether an action that the target suspect file could perform upon being executed would exhibit malicious behavior; and
denying, by the computer system in response to determining that the action would exhibit malicious behavior, entry of the target suspect file into a computing environment.

11. The method of claim 10, further comprising:
interpreting, by the computer system, the code of the target suspect file to determine that the detection-avoidance technique is a potential environment check.

12. The method of claim 11, further comprising:
interpreting, by the computer system, the code of the target suspect file to determine that a first action of the set of actions would be a read instruction of data that would be indicative of a particular characteristic or feature of the computing environment; and
interpreting, by the computer system, the code of the target suspect file to determine that a second action of the set of actions would be a conditional test that would use the data that would have been read;
wherein:
the read instruction and the conditional test are the potential environment check.

13. The method of claim 12, further comprising:
obtaining, by the computer system, the data by emulating the read instruction.

14. The method of claim 10, further comprising:
interpreting, by the computer system, a first instruction that the target suspect file would perform upon being executed as part of a reconnaissance stage of a multi-stage attack.

15. The method of claim 14, further comprising:
interpreting, by the computer system, a second instruction that the target suspect file would perform upon being executed as part of an attack stage of a multi-stage attack.

16. The method of claim 10, further comprising:
interpreting, by the computer system, the code of the target suspect file to determine that the detection-avoidance technique is a sleep-delay technique with a sleep instruction that would cause the target suspect file not to be executed for a period of time; and
emulating, by the computer system, the sleep instruction to complete it immediately.

17. The method of claim 10, further comprising:
interpreting, by the computer system, the code of the target suspect file to determine that the detection-avoidance technique includes an instruction repeated in a loop; and
exiting, by the computer system, the loop after detecting a predetermined number of the instruction.

18. The method of claim 10, further comprising:
interpreting, by the computer system, the code of the target suspect file to determine that the code of the target suspect file includes multiple execution paths; and
interpreting, by the computer system, the code of the target suspect file to determine an action that the target suspect file could perform upon being executed for an execution path of the multiple execution paths that is dependent on a conditional test.

19. The method of claim 10, further comprising:
interpreting, by the computer system, the code of the target suspect file to determine that the detection-avoidance technique includes a first execution path that the target suspect file would perform in response to an environment check producing a first result;
interpreting, by the computer system, the code of the target suspect file to determine that code of the first execution path would exhibit non-malicious behavior;
interpreting, by the computer system, the code of the target suspect file to determine that the detection-avoidance technique includes a second execution path that the target suspect file would perform in response to the environment check producing a second result; and
interpreting, by the computer system, the code of the target suspect file to determine that code of the second execution path would exhibit the malicious behavior.

20. The method of claim 10, wherein:
the interpreting functions are performed without executing the code of the target suspect file.
